(19) United States
(12) Patent Application Publication
(10) Pub. No.: US 2005/0109465 A1
(43) Pub. Date: May 26, 2005

(54) Apparatus and method for making garments starting from a knitted hose

(75) Inventor: Gino Bassi, San Giovanni in Persiceto (IT)

Correspondence Address: DENNISON, SCHULTZ, DOUGHERTY & MACDONALD, 1727 KING STREET, SUITE 105, ALEXANDRIA, VA, 22314, US

(73) Assignee: MATEC S.p.A.

(21) Appl. No.: 10/935,717

(22) Filed: Sep. 8, 2004

(30) Foreign Application Priority Data
Sep. 7, 2003 (EP) 03425605.7

(51) Int. Cl. B32B 1/00

(52) U.S. Cl. 156/391

(57) ABSTRACT

An apparatus (50) to provide knitted articles starting from a knitted hose has a tubular support (1) and a head of application (10) that fixes an elastic band (30) on the knitted hose (60) put on support (1) same. The elastic band (30) is fixed to the knitted hose (60) at edges which are cut following the desired shape of the article. In case of pants, the knitted hose (60) is initially subject to a step of making the apertures for the legs and then to applying elastic bands at the edges. Tubular support (1) is brought into rotation by a motor (25) about an electronically controlled axis (5) and cooperates with the head of application (10) sliding along a direction (16) and rotating about an axis (15) orthogonal to the axis of the support (1). A combined relative motion between support (1) and head (10) allows, then, to apply the band (30) at the edges of hose (60) with high precision and at a high speed. The head of application (10) can be moved according to two degrees of freedom pivotally connecting it by an arm (11) to a carriage (71) sliding on a guide (72) in direction (16).

The angular position of the axis (5) of tubular support (1) can be instantly measured, for example, by coupling the motor (25) to an encoder, or a resolver, or a potentiometer, etc. Similarly, it is possible to know the position of the head of application (10) in order to carry out the application of elastic band (30) on the cut edges of hose (60) with high precision.

### FIELD OF THE INVENTION

The present invention relates to the field of textiles and more precisely it relates to an apparatus to make knitted articles in particular for underwear such as bodysuits, pants and shirts starting from a knitted hose.

Furthermore, the invention relates to a manufacturing method using this apparatus.

### BACKGROUND OF THE INVENTION

As known, for the production of seamless garments circular knitting machines are normally used. This kind of machines allows to obtain knitted hose portions that are then collected and subject to further finishing operations to provide a predetermined final product.

In case of underwear, like pants, bodysuits, or shirts, starting from a knitted hose, in a first cutting step the apertures for the legs and for the arms are made. Then, elastic bands are applied at the edges of the apertures made on the hose.

In particular, the application of the elastic band on the hose, made by seaming, is obtained through a succession of operations each of which is made on appropriate machines. In particular, the production process provides a first machine for fixing the elastic band when the cut edges of fabric are still distinct and a second machine for bending the elastic band into the inner side of the hose.

In some cases the article can be subject to further finishing operations. In particular, the machines for cutting the hose and fixing the elastic band, above described, require the aid of at least one operator and involve a slow production process.

Furthermore, the need of different machines causes the production process to be much slower with consequent high costs of production and maintenance. In particular, the use of different machines requires much manual work also for loading/unloading operations of the hose portion.

### SUMMARY OF THE INVENTION

It is therefore a feature of the present invention to provide an apparatus to make knitted articles for underwear such as bodysuits, pants and shirts starting from a knitted hose that achieves an automatic application, i.e. without operator, of elastic bands to such garments.

It is another feature of the present invention to provide such an apparatus for working automatically at a higher production rate than the prior art.

It is another feature of the present invention to provide such an apparatus that allows to obtain in a single passage the cutting step of the fabric and the fixing step of the elastic band to the edge automatically without the aid of the operator.

These and other features are accomplished with one exemplary apparatus to make knitted articles starting from a knitted hose whose characteristic is that it comprises:
at least one tubular support capable of rotating about at least one axis, on said tubular support being put the knitted hose,
a head for automatic application of an elastic element at an edge made on said hose, said head being movable with respect to said support along at least one working direction.

In particular, the application to the hose of the elastic element, for example an elastic band, is made by combined relative motion between the tubular support and the head. This way, it is possible to operate the head for an application along the edge of the elastic band quick and precise.

Advantageously, the tubular support has a shaped side surface defining a rim suitable for allowing the head to proceed unimpeded along the edge at which the elastic band is mounted.

In particular, the shaped tubular support is associated to an auxiliary tubular support that in use completes its side surface to allow a correct placing the hose before proceeding with the cutting step.

Preferably, the tubular support is peripherally equipped with a plurality of holes in communication with a suction system suitable for causing the garment to adhere on the support surface in order to assure its correct position during the operation.

Advantageously, the tubular support is peripherally equipped with a plurality of holes in communication with a suction system suitable for causing the garment to adhere on the support surface in order to assure its correct position during the operation.

Advantageously, the auxiliary tubular support is arranged according to the shaped tubular support and is sliding coaxially to it between a first position where it has at least one cylindrical portion exceeding the edge of the shaped tubular support and a second position where the edge same is freed to allow the head to work correctly.

More in detail, to carry out also a cut on the tubular support, this has a continuous side surface to let the cutting tool to work properly. At the end of the cutting step, the auxiliary tubular support withdraws telescopically so that during the step of application of the elastic band the shaped tubular support has the rim free and substantially covers the edge on which to apply the elastic band. This way, the head applies the elastic band on the edge of the cut hose with a high freedom of movement thus allowing high speed working.

A first exemplary embodiment of the apparatus to make knitted articles starting from a knitted hose provides that the head that applies the elastic band is a seaming machine movable along a working direction and capable of rotating about an axis substantially orthogonal to the axis of the tubular support.

In this case, the elastic element can be an elastic band mounted by the seaming machine on the hose.

In particular, the tubular support is arranged to work with horizontal axis and the seaming machine is pivotally connected to a carriage movable along said working direction substantially parallel to the axis of rotation of the tubular support.

The exemplary embodiment above described provides that the edge is created on the hose in a step previous to the step of application of the elastic element, for example by means of laser cutting step.

In an alternative exemplary embodiment of the invention the edge can be made contemporaneously of application of the elastic band.

In this case, the head can comprise application means using ultrasonic pulses that fix the elastic band on the knitted hose through a partial melting of the parts to join with each other. In particular, by the high mechanical vibration produced, the elastic band is fixed to the hose without substantial changes to the molecular structure of the joined parts. This does not affect the elasticity of the elastic band and then optimizes the application step.

Advantageously, said application means of ultrasonic pulses have an application tool with profile formed by two opposing faces inclined according to predetermined angles. In particular, a first portion of said application tool of ultrasonic pulses ending at a first face carries out a cut whereas a second portion defined by the second face carries out the welding the elastic with the fabric of the article.

Preferably, the portion of said application means using ultrasonic pulses for welding the elastic with the fabric has a wavy protruding profile. In particular, in operative conditions the elastic element is welded to the fabric located underneath only at the points that are in contact with the wavy profile. This provides a discontinuous welding of the elastic element that leaves substantially unchanged the elastic features.

Advantageously, said head is movable along a first and a second working direction substantially orthogonal to each other and can rotate about an axis parallel to said second direction.

According to another aspect of the invention, a method for making knitted articles starting from a knitted hose provides the steps of:
arranging a knitted hose on a tubular support,
placing said tubular support at a head for automatic application of an elastic element at an cut edge on said article,
moving said head and said tubular support relative to each other for causing the head to follow said cut edge on said article.

In particular, the elastic element is fed controlling its tension at the interaction between the head of application and the tubular support, for example, unwinding it starting from a roll. this allows to adjust the tension of the elastic element at the point of application.

Advantageously, the edge is created by cutting the knitted hose contemporaneously to the step to apply the elastic element.

### BRIEF DESCRIPTION OF THE DRAWINGS

Further characteristics and the advantages of the apparatus to make knitted articles starting from a knitted hose, according to the present invention, will be made clearer with the following description of an exemplary embodiment thereof, exemplifying but not limitative, with reference to the attached drawings, in which like reference characters designate the same or similar parts throughout the figures of which:

figures from 1 to 5 show diagrammatically in perspective views some possible relative positions between a tubular support and a head of application of an elastic band to a hose according to a first exemplary embodiment of the apparatus to make knitted articles starting from a knitted hose, of the invention;

FIG. 6 shows a perspective view of a possible exemplary embodiment of a tubular support used in the apparatus of figures from 1 to 5 in a configuration during the cutting step;

FIG. 7 shows a perspective view of the tubular support of FIG. 6 in a configuration during the application of an elastic band to a hose;

FIG. 8 shows a perspective view of a possible exemplary embodiment of the tubular support of FIG. 6 in in a configuration during the cutting step;

FIG. 9 shows a perspective view of the tubular support of FIG. 3 in a configuration during the application of an elastic band to a hose;

figures from 10 to 12 show diagrammatically in elevational front views a possible succession of steps to provide knitted articles starting from a knitted hose using an alternative exemplary embodiment of the apparatus shown in figures from 1 to 5;

FIGS. 13 and 14 show respectively in a partially cross sectioned view and a perspective view a possible exemplary embodiment of the application means using ultrasonic pulses mounted on the head of figures from 10 to 12;

FIGS. 13 and 14 show respectively in a partially cross sectioned view and a perspective view a possible exemplary embodiment of the application means using ultrasonic pulses mounted on the head of figures from 10 to 12;

FIGS. 15 and 16 show respectively in a partially cross sectioned view and a perspective view an exemplary embodiment of the application means using ultrasonic pulses alternative to that of FIGS. 13 and 14.

### DESCRIPTION OF A PREFERRED EXEMPLARY EMBODIMENT

With reference to figures from 1 to 5 an apparatus 50 to provide knitted articles starting from a knitted hose, according to the present invention, comprises a tubular support 1 and a head of application 10 that fixes an elastic band 30 on the knitted hose 60 put on support 1 same. In an exemplary embodiment shown in figures from 1 to 5 the head of application 10 is a seaming machine that fixes elastic band 30 to hose 60 by means of stitches. In particular, the fixing of elastic band 30 on the knitted hose 60 is carried out at edges which are cut following the pattern of the article to make. For example, in case of pants, the knitted hose 60 is initially subject to a step of making the apertures for the legs and then to a step to apply elastic bands at the edges.

More in detail, tubular support 1 is brought into rotation by a motor 25 about an electronically controlled axis 5 and cooperates with the head of application 10 sliding along a direction 16 and capable of rotating about an axis 15 orthogonal to the axis of support 1. A combined relative motion between support 1 and head 10 allows, then, to apply the band 30 at the edges of hose 60 with high precision and at a high speed. The head of application 10 can be moved according to two degrees of freedom pivotally connecting it by an arm 11 to a carriage 71 sliding on a guide 72 in direction 16.

The angular position of the axis 5 of tubular support 1 can be instantly measured, for example, by coupling the motor 25 to an encoder, or a resolver, or a potentiometer, etc. Similarly, it is possible to know the position of the head of application 10 in order to carry out the application of elastic band 30 on the cut edges of hose 60 with high precision.

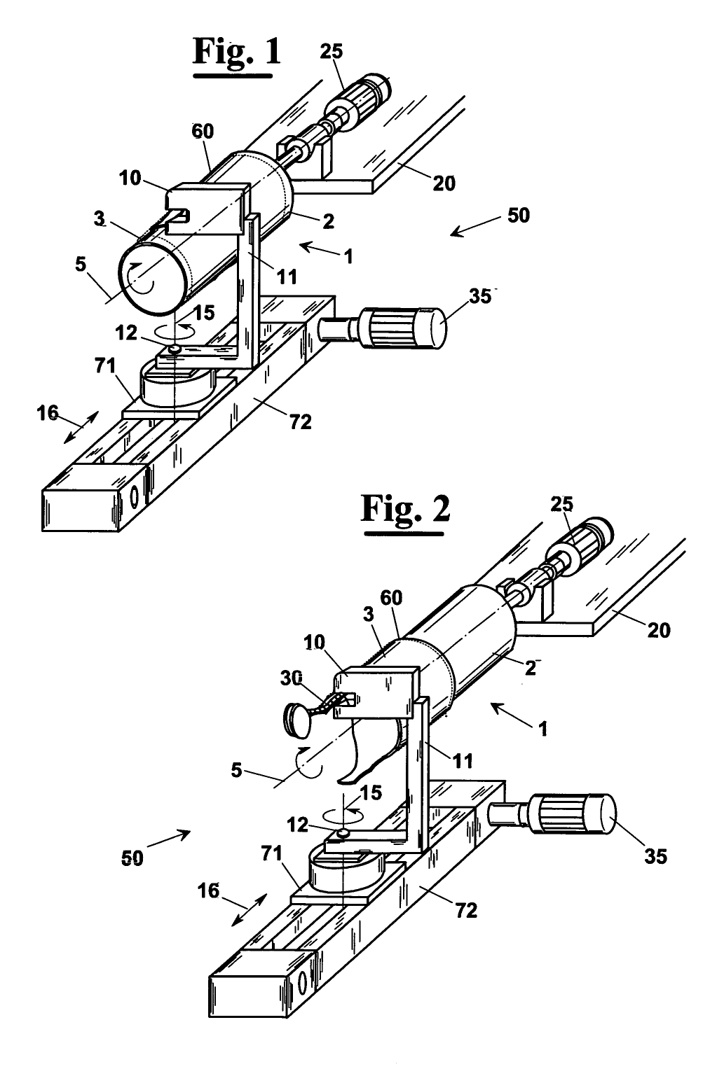

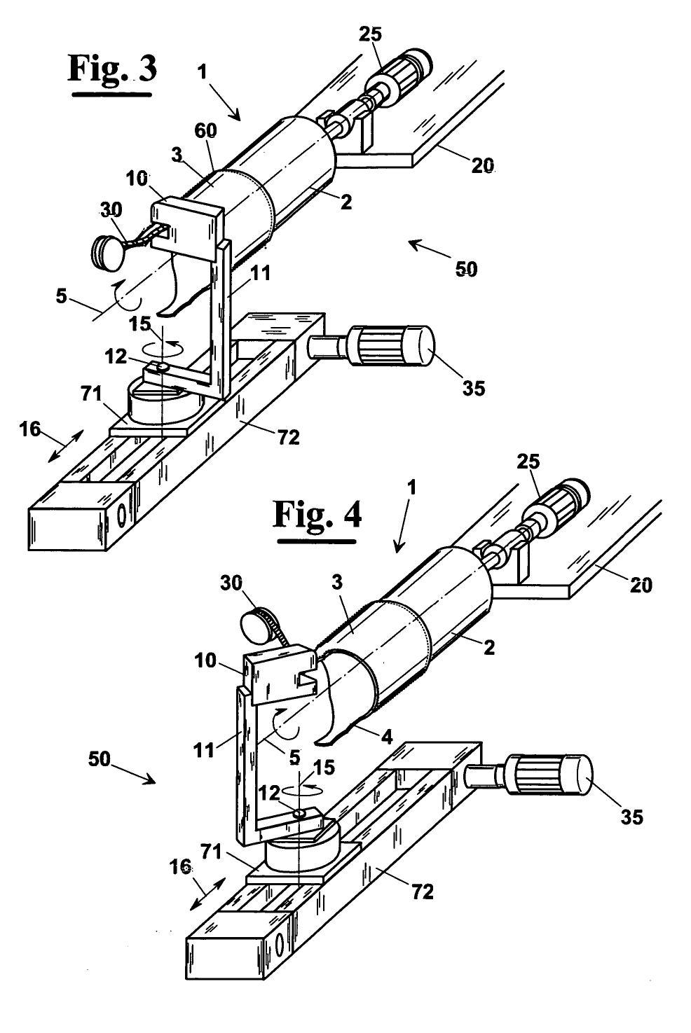

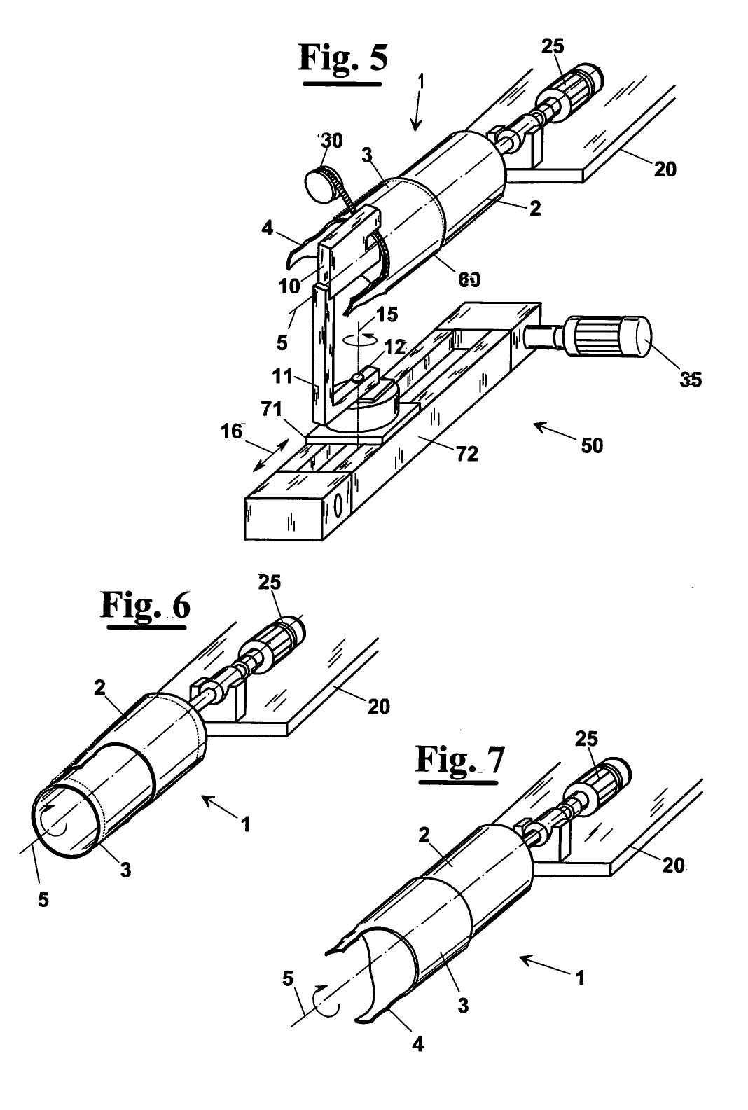

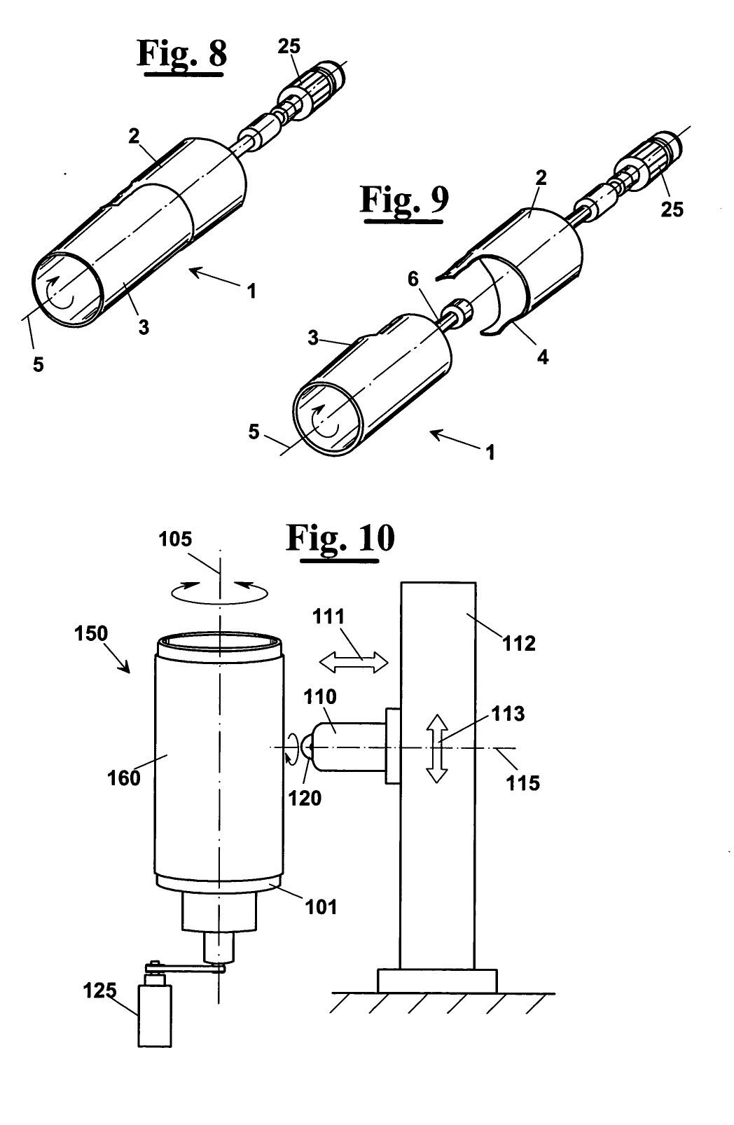

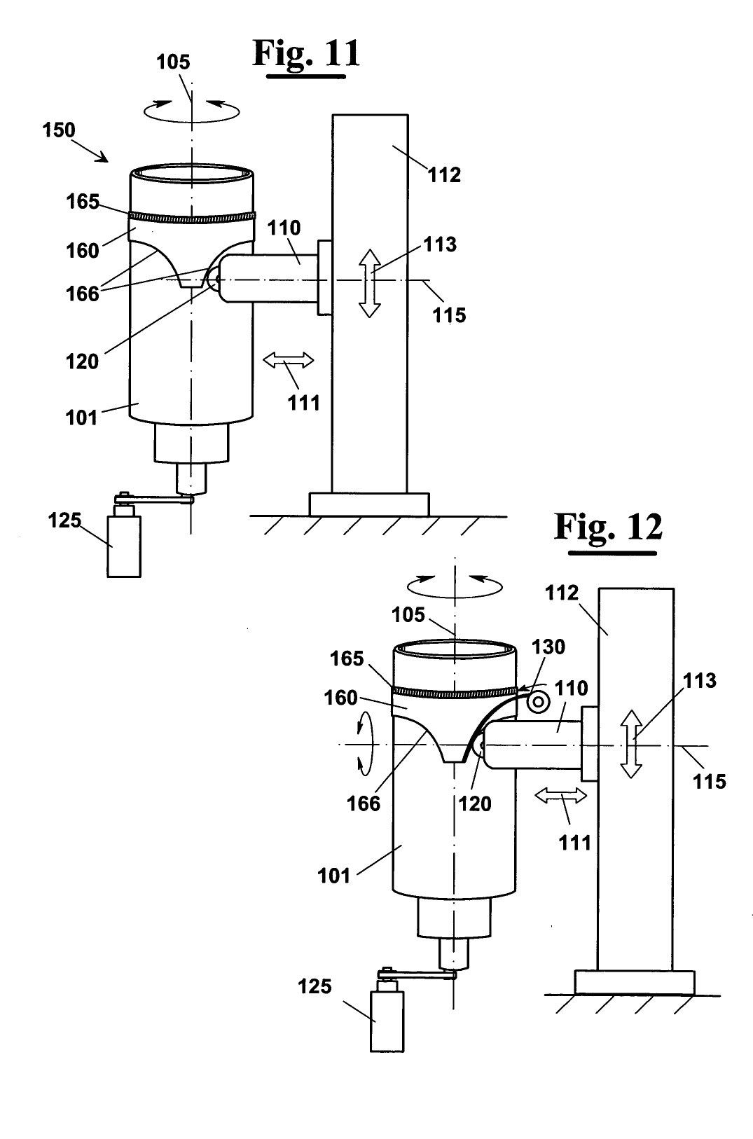

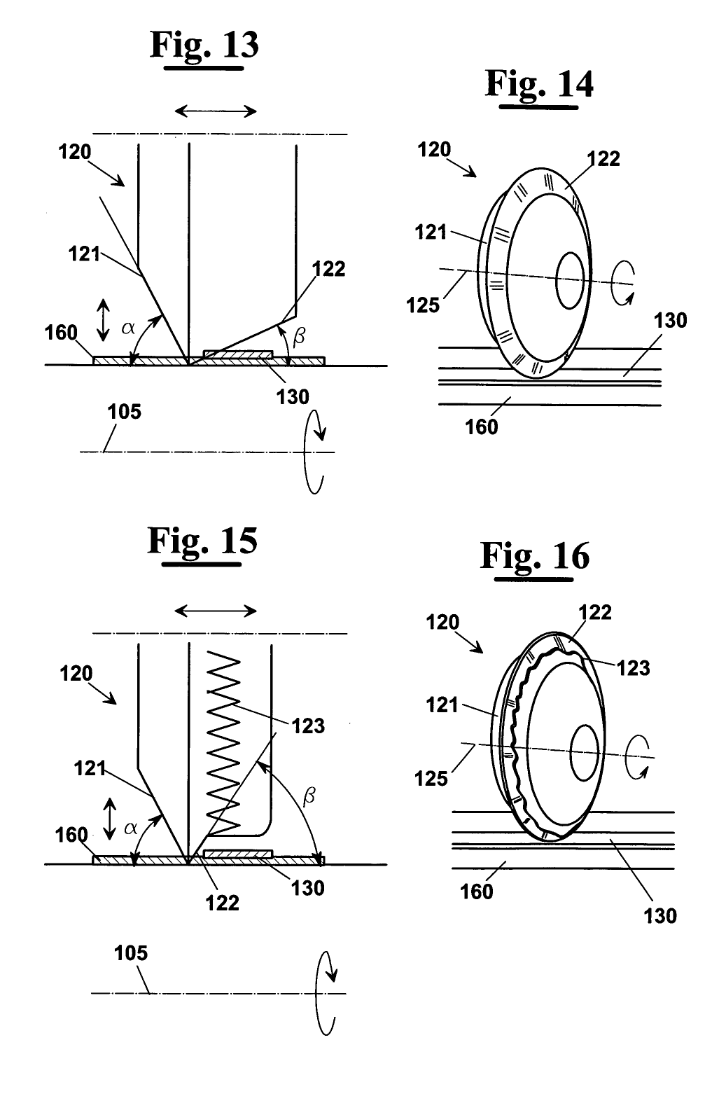

For allowing the motion of seaming machine 10 during the step of application of band 30, tubular support 1 has a shaped rim 4 that follows the cut edge of hose 60. In particular, for a cutting step on tubular support 1 the latter has a first part 2 having the shaped rim 4 and a second part 3 that in a first configuration engages with the first part 2 to complete its side cylindrical surface in order to causing the cutting tool to work properly (FIG. 6 and 8). At the moment of fixing band 30 to the knitted hose 60 tubular support 1 assumes a second configuration where the shaped rim 4 is freed to let seaming machine 10 to follow the cut edge on hose 60 (FIG. 7 and 9). When moving tubular support 1 from a configuration to the other the parts 2 and 3 move telescopically on each other (FIG. 6 and 7). Alternatively, parts 2 and 3 can move towards/away from the head (FIG. 8 and 9). The particular arrangement of tubular support 1 with horizontal axis shown in figures from 1 to 5 is provided in the case, for example, a seaming machine 10 is used provided with an hydraulic lubrication circuit. In this case, in fact, it is not possible to use seaming machine 10 up to a vertical position for problems of loss of lubricant, which could affect the correct operation of the machine same and causing it to break.

In figures from 10 to 12 an exemplary embodiment is shown of the apparatus 150 alternative to that above described. In this case, the head of application 110 comprises application means using ultrasonic pulses 120 that fix the elastic band 130 on the fabric of the hose 160 through a partial melting of the parts to join with each other. In particular, by the high mechanical vibration produced the elastic band is fixed 130 to the fabric 160 without substantial changes to the molecular structure of the joined parts. This allows not to change substantially the elastic features of the used materials for elastic band 130 and then to optimize the applying step. In this case, since a lubrication fluid of the head 110 is not provided it is possible to arrange the tubular support 101 with vertical axis of rotation 105.

As shown in detail in figures from 13 to 16 the application means using ultrasonic pulses 120 comprise a circular blade with profile formed by two faces 121 and 122 opposed and inclined according to angles α and β. In particular, the first face 121 carries out a cut whereas the second face 122 carries out the welding of the elastic 130 on the hose 160.

To provide a discontinuous welding of the elastic 130 on the hose 160 the application means use ultrasonic pulses 120 and can have a wavy protruding profile 123. In particular, in operative conditions, the elastic 130 is welded to the fabric 160 located underneath only at the points that are in contact with the wavy profile 123.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. Apparatus to make knitted articles starting from a knitted hose characterised in that it comprises:
at least one tubular support capable of rotating about at least one axis, the knitted hose being put on said tubular support,
a head for automatic application of an elastic element at an edge made on said hose, said head being movable with respect to said support along at least one working direction.

2. Apparatus, according to claim 1, where the application to the hose of said elastic element is made by a combined relative motion between said tubular support and said head.

3. Apparatus, according to claim 1, wherein said tubular support is peripherally equipped with a plurality of holes in communication with a suction system suitable for causing the garment to adhere on the support surface in order to assure its correct position during the operation.

4. Apparatus, according to claim 1, wherein said tubular support has a shaped side surface defining a rim suitable to let said head to proceed unimpeded along said edge at which said elastic element is mounted.

5. Apparatus, according to claim 4, wherein said shaped tubular support is associated to an auxiliary tubular support that in use completes its tubular side surface to place correctly said hose before the cutting step.

6. Apparatus, according to claim 5, wherein said auxiliary tubular support is arranged according to said shaped tubular support and is sliding coaxially to it between a first position where it has at least one cylindrical portion exceeding said edge of said shaped tubular support and a second position where said edge is freed to let said head to work properly.

7. Apparatus, according to claim 1, wherein said head of the elastic element is a seaming machine movable along a working direction and capable of rotating about an axis substantially orthogonal to said axis of said tubular support.

8. Apparatus, according to claim 7, wherein said elastic element is an elastic band applied by said seaming machine on said hose.

9. Apparatus, according to claim 7, wherein said tubular support is arranged to work with horizontal axis and said seaming machine is pivotally connected to a carriage movable along said working direction substantially parallel to said axis of rotation of said tubular support.

10. Apparatus, according to claim 1, wherein said head comprises application means using ultrasonic pulses that fix said elastic element on said hose through a partial melting of the parts to join with each other.

11. Apparatus, according to claim 10, wherein said application means using ultrasonic pulses have an application tool with profile formed by two opposing faces inclined according to predetermined angles, said application tool comprising a first portion ending at said first face that carries out a cut and a second portion defined by said second face that carries out the welding of said elastic element with said hose.

12. Apparatus, according to claim 11, wherein said application means using ultrasonic pulses for welding said elastic element and said hose have a wavy profile protruding, said elastic element being welded to the fabric located underneath only at the points that are in contact with said wavy profile.

13. Apparatus, according to claim 11, wherein said head is movable along a first and a second working direction substantially orthogonal to each other and can rotate about an axis parallel to said second direction.

14. Method for making knitted articles starting from a knitted hose characterised in that it provides the steps of:
arranging a knitted hose on a tubular support,
placing said tubular support at a head for automatic application of an elastic element at an cut edge on said article,
feeding said elastic element at the interaction between said head and said tubular support;
moving said head and said tubular support relative to each other for causing the head to follow said cut edge on said article.

15. Method, according to claim 14, wherein said edge is created by means cutting the knitted hose contemporaneously to the applying said elastic element.
